(19) United States
(12) Patent Application Publication
(10) Pub. No.: US 2016/0325640 A1
(43) Pub. Date: Nov. 10, 2016

(54) E-BIKE TRAILER CONTROL

(71) Applicant: Ford Global Technologies, LLC, Dearborn, MI (US)

(72) Inventor: Richard Craven, Chelmsford/Essex (GB)

(73) Assignee: Ford Global Technologies, LLC, Dearborn, MI (US)

(21) Appl. No.: 14/704,132

(22) Filed: May 5, 2015

(51) Int. Cl. B60L 15/38; B60L 15/20; B62D 53/00; B62K 11/00; B62D 59/04

(52) U.S. Cl. CPC B60L 15/38; B62K 11/00; B62D 59/04; B62D 53/00; B60L 15/20; B62K 2202/00; B62K 2204/00

(57) ABSTRACT

A target speed of an electric bicycle is determined. A first motor controller of the electric bicycle is instructed to adjust a first motor to substantially achieve the target speed. A second motor controller of an electric-powered trailer connected to the electric bicycle is instructed to adjust a second motor to substantially achieve the target speed.

### BACKGROUND

Bicycles powered by electric motors, sometimes referred to as electric bicycles or eBikes, generally have limitations on an amount of power that can be output to the electric motor. For example, regulations in many jurisdictions impose such limits. EBike power limits implicitly impose restrictions on a volume and variety of loads that may be transported by any bike. In particular, it may be difficult for an eBike to tow a trailer, particularly if the trailer is carrying a load. Therefore, in some instances, an eBike trailer, referred to herein as an E-trailer, may be powered by a separate electric motor. Where an eBike and an e-trailer attached to the eBike are powered by respective electric motors, the difficulty arises of ensuring that the motors are powered to proceed at the same speed.

### BRIEF DESCRIPTION OF THE DRAWINGS

FIG. 1 is a block diagram of an exemplary eBike towing system,

FIG. 2 is a process flow diagram illustrating an exemplary process for the system of FIG. 1.

### DESCRIPTION

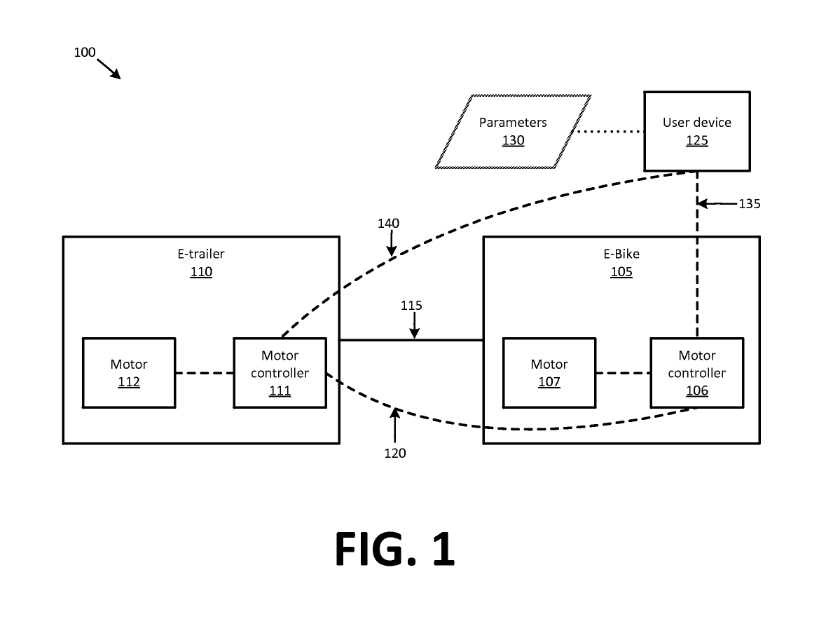

FIG. 1 is a block diagram of an exemplary towing system 100 for an eBike 105. The eBike 105 generally includes a motor controller 106 that is included in or communicatively coupled to an electric motor 107. An E-trailer 110 similarly includes a motor controller 111 included in or communicable coupled to an electric motor 112. The eBike 105 and E-trailer 110 may be coupled by a mechanical towing connection 115, such as is known, e.g., a towbar, cable, etc. further, a communications link 120 may be provided between the eBike 105 and the e-trailer 110. For example, a wire harness or the like, such as is known, may be provided to provide instruction, actuation, etc., of components of the E-trailer 110 from the eBike 105, e.g., lights, turn signals, etc. Further, the link 120 may include other wired and/or wireless mechanisms, e.g., Bluetooth or the like, to allow the eBike 105 motor controller 106 two communicate with the e-trailer 110 motor controller 111. A portable user device 125, e.g., a smart phone or the like, which may store control parameters 130 relating to control of the eBike 105 motor controller 106, may use a communications link 135, e.g., Bluetooth, a docking port on the eBike 105, or some other mechanism such as may be known, to communicate with the motor controller 106. In addition, the user device 125 may advantageously communicate with the motor controller 111 on thee-trailer 110, so that the device 125 may provide instructions to each of the eBike 105 motor controller 106 and the E-trailer 110 motor controller 111 to generate an amount of torque and/or achieve a speed such that the eBike 105 and the e-trailer 110 travel at a same speed.

The eBike 105 is generally known for including the electric motor 107 to assist with and/or replace user peddling. As is known, the motor 107 may be a so-called center mount, i.e., mounted at or near a pedal sprocket assembly, or may be a so-called rear mount, i.e., mounted on a rear wheel of the eBike 105 at or near a rear wheel sprocket assembly. In any case, a motor controller 106 may be used to govern an amount of power supplied to the motor 107, an amount of torque provided by the motor 107, a speed of the eBike 105, etc. The motor controller 106 generally includes a processor and a memory, the memory storing instructions executable by the processor to provide such control to the motor 107. The motor controller 106 may use sensors, actuators, etc., such as are known to obtain feedback from and provide instructions to the motor 107.

Further, the motor controller 106 is generally configured, e.g., includes hardware for radio frequency communications, appropriate programming, etc., for wired and/or wireless communications, e.g., with a user device 125 via a communications link 135, e.g., a Bluetooth link or the like as discussed above. Accordingly, the user device 125 can accept user input regarding a desired level of assistance, etc., and can transmit an appropriate instruction to the motor controller 106 regarding such desired speed (also referred to as a target speed), level of assistance, etc., whereupon the motor controller 106 can control the motor 107, by specifying a power level, torque, etc., to achieve the desired, level of assistance, etc. Further, as is known, the motor controller 106 can operate according to a feedback loop, e.g., by measuring a speed achieved by applying a specified level of torque, the motor controller 106 can raise or lower a specified level of torque to raise or lower an eBike 105 speed to more closely approximate or match a user-requested speed.

The E-trailer 110 is also generally known for including the electric motor 11.2, e.g., attached to a central drive mechanism for driving one or more wheels of the e-trailer 110. Further, the motor controller 111 may receive inputs, e.g., desired speed, torque, etc. that may then be translated to an instruction for a power level, a torque, etc., to be applied in and/or output from the motor 112. As mentioned above, the E-trailer 110 may be coupled to the eBike 105 by a mechanical towing connection 115, e.g., providing attachment of the e-trailer to the eBike 105 as well as wiring and the like between the e-trailer 110 and the eBike 105. Further, as also mentioned above, the motor controller 106 and the motor controller 111 may communicate via a communication link 120, e.g., a Bluetooth link or the like. Accordingly, the comptrollers 106, 111 may be configured, e.g., include hardware and/or programming for such communications, as are known,

A user device 125 may be any one of a variety of portable computing devices including a processor and a memory, as well as communication capabilities. For example, the user device 125 may be a tablet computer, a smart phone, etc. that includes capabilities for wireless communications using IEEE 802.11, Bluetooth, and/or cellular communications protocols. The user device 125 may use a known operating system, such as iOS from Apple Corp., or the Android OS from Google, Inc. Further, the user device 125 may use such communication capabilities to communicate via a communications link 135 including with a controller 106 and/or 111. A user device 125 may use protocols such as Bluetooth, etc. Further, a user device 125 generally includes a human machine interface (HMI), e.g., a microphone, speakers, a display screen, possibly capable of touch input, etc. As mentioned above, the device 125 generally communicates with the motor controller 106 via a communications link 135, e.g., using Bluetooth or the like; alternatively or additionally, the communications link 135 may include a docking port or the like, e.g., a universal serial bus (USB) or micro-universal serial bus (micro-USB) connection on the eBike 105 to the motor controller 106. Further, the user device 125 may instruct the motor controller 106 to provide instructions via the communications link 122 the motor controller 111, and/or may establish a separate communications link 140 with the controller 111.

Parameters 130 may be received and/or stored in a memory of the user device 125 for determining instructions to be provided to the controller 106 and/or the controller 111. For example, a user may provide input to the device 125 indicating a desired speed of the eBike 105, the desired speed then being stored as a parameter 130. A user could alternatively or additionally provide input to the device 125 indicating a desire assist level, e.g., a level 5 out of 10 assist level, etc. The desire to assist level could likewise be stored as a parameter 130. Yet further alternatively or additionally, a parameter 130 could be determined by receiving data from one or more sensors on the eBike 105 and/or e-trailer 110. For example, the eBike 105 could provide, e.g., from a sensor there on, an indication to the user device 125 of a current speed of the eBike 105. Likewise, the eBike 105 could provide, e.g., from a sensor and/or from data obtained from the motor controller 106, an indication of an amount of power being supplied to the motor 107, an amount of torque being generated by the motor 107, etc. such values could be stored as parameters 130.

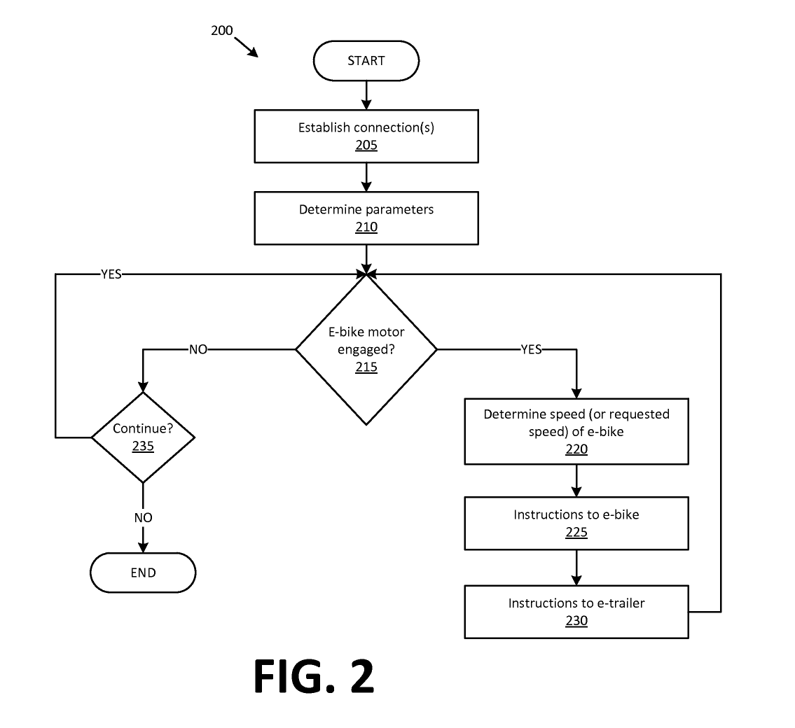

FIG. 2 is a process flow diagram illustrating an exemplary process 200 for control of eBike 105 and E-trailer 110 motors 107, 111.

The process 200 begins in a block 205, in which the user device 125 establishes the communications link 135 with the eBike 105 motor controller 106. Further, the motor controller 106 may establish the communications link 120 with the E-trailer 110 motor controller 111 and/or the user device 125 may establish the separate communications link 140 with the e-trailer 110 motor controller 111.

Next, in a block 210, the user device 125 determines parameters 130. For example, the user device 125 may determine a desired speed of the eBike 105 as described above. Further for example, as also mentioned above, the user device 125 could receive a current speed of the eBike 105 via the communications link 135, and could store this value as a parameter 130. Other parameters 130 could be received in the block 210 as described above.

Next, in a block 215, the user device 125 determines whether the &Bike 105 motor 107 is engaged, i.e., whether the motor has been actuated and is generating torque used to assist in movement of the eBike 105. For example, this information may be provided via the communications link 135 from the motor controller 106. If the eBike 105 motor 107 is not presently engaged, then a block. 235 is executed next. Otherwise, the process 200 proceeds to a block 220.

In the block 220, the user device 125 determines a current or requested speed of the eBike 105, e.g., as stored in a parameter 130 as discussed above. Alternatively or additionally, the user device 125 could, in the block 220, determine a torque being generated by the motor 107, a power level being provided to the motor 107, etc.

Following the block 220, in a block 225, the user device 125 provides an instruction to the motor controller 106 to control the motor 107. For example, the instruction could specify a target speed of the eBike 105, whereupon the motor controller 106 could include programming to determine an appropriate amount of torque to be applied by the motor 107 to achieve the desired speed, possibly taking into account a desire to power assist level and/or an amount of torque being applied by user pedaling, e.g., as is known. The target speed could be simply a current speed of the eBike 105, or could be a user-requested speed, as described above.

Next, in a block 230, the user device 125 provides an instruction to the e-trailer 110 motor controller 111 to control the e-trailer 110 motor 112, e,g., to achieve the target speed specified in the block 225. That is, in general, such instruction may be based on a desired speed of the e-trailer 110, e.g., a speed matching or substantially matching a speed of the eBike 105. For example, a speed value may be supplied to the motor controller 111, and, in a known manner, the motor controller 111 may include programming to instruct the motor 112 to output a torque, or to receive a power value, to cause the e-trailer 110 to travel at substantially the specified speed value. Following the block 230, the process 200 returns to the block 215.

As mentioned above, a block 235 may be executed following the block 235, when the user device 125 determines that the eBike 105 motor 107 is not engaged, i.e., is not being used to generate torque to assist in movement of the eBike 105. In that event, in the block 235, the user device 1125 may determine whether to continue the process 200. For example, the device 125 may determine that the eBike 105 is stopped, or traveling at a speed below a threshold speed, e.g., five kilometers per hour, at which the process 200 is to be carried out. In such event, the process 200 may end. Further, the process 200 may end at any point if the device 125 is powered off, a communications link 135, 120, etc. is broken, or for some other similar reason.

### CONCLUSION

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices such as those discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, C#, Visual Basic, Java Script, Peri, HTML, PUP, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system comprising a computing device that is programmed to:
determine a target speed of an electric bicycle;
instruct a first motor controller of the electric bicycle to adjust a first motor to provide a first amount of torque based on the target speed; and
instruct a second motor controller of an electric-powered trailer connected to the electric bicycle to adjust a second motor to provide a second amount of torque based on the target speed.

2. The system of claim 1, wherein the computing device is further programmed to instruct each of the first motor controller and the second motor controller concerning a target level of pedaling assistance.

3. The system of claim 1, wherein the target speed of the electric bicycle is one of a current speed of the electric bicycle and a speed specified by user input.

4. The system of claim 1, wherein the computing device is the first motor controller.

5. The system of claim 1, wherein the computing device is the second motor controller.

6. The system of claim 1, wherein the computing device is further programmed to provide the instruction to the second motor controller via the first motor controller.

7. The system of claim 1, wherein the computing device is further programmed to determine whether the first motor is engaged before providing an instruction including the target speed to the second motor controller.

8. The system of claim 1, wherein the computing device is a smartphone.

9. A system, comprising:
an electric bicycle including a first motor;
an electric-powered trailer including a second motor controller and a second motor; and
a portable computing device that is programmed instruct the second motor controller to adjust the second motor to provide a first amount of torque based on a target speed of the electric bicycle.

10. The system of claim 9, wherein the electric bicycle further comprising a first motor controller that is programmed to instruct the first motor and to provide the target speed to the portable computing device,

11. The system of claim 9, wherein the portable computing device is further programmed to receive the target speed via at least one of user input and a message from the electric bicycle.

12. The system of claim 9, further comprising a connection by which the electric bicycle and the trailer are connectable.

13. The system of claim 12, wherein the electric bicycle and the trailer are connected by the connection.

14. A method, comprising:
determining a target speed of an electric bicycle;
instructing a first motor controller of the electric bicycle to adjust a first motor to provide a first amount of torque based on the target speed; and
instructing a second motor controller of an electric-power d trailer connected to the electric bicycle to adjust a second motor to provide a second amount of torque based on the target speed.

15. The method of claim 14, further comprising instructing each of the first motor controller and the second motor controller concerning a target level of pedaling assistance.

16. The method of claim 14, wherein the target speed of the electric bicycle is one of a current speed of the electric bicycle and a speed specified by user input.

17. (canceled)

18. (canceled)

19. The method of claim 14, further comprising providing the instruction to the second motor controller via the first motor controller.

20. The method of claim 14, further comprising determining whether the first motor is engaged before providing an instruction including the target speed to the second motor controller.
